(19) United States
(12) Patent Application Publication
(10) Pub. No.: US 2022/0138891 A1
(43) Pub. Date: May 5, 2022

(54) RIDESHARE PARCEL COLLECTION

(71) Applicant: United States Postal Service, Washington, DC (US)

(72) Inventor: Donald E. IRWIN, Fredericksburg, VA (US)

(21) Appl. No.: 17/508,240

(22) Filed: Oct. 22, 2021

Related U.S. Application Data
(60) Provisional application No. 63/109,899, filed on Nov. 5, 2020.

(51) Int. Cl. G06Q 50/32; G06Q 10/02

(52) U.S. Cl. CPC G06Q 50/32; G06Q 10/02

(57) ABSTRACT

A system including a processor and a non-transitory computer-readable medium communicatively coupled to the processor and storing instructions executable by the processor is provided. When executed, the instructions cause the processor to receive, from a user, a rideshare request comprising an origination point and a destination location, determine that one or more parcels destined for delivery to the user are available for collection, identify, based on a collection location associated with each of the one or more parcels and at least one of the origination point and the destination location, a route that enables collection of at least one of the one or more parcels, and direct a rideshare operator to the collection location associated with at least one of the one or more parcels.

### CROSS-REFERENCE TO RELATED APPLICATIONS

This application claims the benefit of, and priority to, U.S. Provisional Patent Application No. 63/109,899 filed on 5 Nov. 2020, the contents of which is hereby incorporated by reference in its entirety.

### FIELD OF THE DISCLOSURE

The present disclosure relates to parcel delivery and collection, and more particularly to systems and methods enabling a rideshare user to facilitate collection of one or more parcels for delivery.

BACKGROUND OF THE DISCLOSURE

Parcel or item delivery has become more and more important as consumers perform more and more shopping tasks online. When a parcel delivery arrives at a delivery location, many consumers are often either not at the delivery location to accept the delivery item or unavailable to answer when a carrier arrives. This can result in missed deliveries and other time losses and inefficiencies, particularly where a signature release is desired or where a user has selected preferences to prevent the carrier from simply leaving the parcel on, for example, the doorstep. In such cases, a carrier often leaves notification of the attempted delivery, and information regarding how the parcel may be collected at a collection location.

A user typically takes the notice regarding missed delivery to the indicated collection location(s) and then waits to be served and then for the item or package to be retrieved. Many users view such a procedure as an inconvenience, particularly when the collection location is physically distant from the user and/or when the wait time at the collection location is long.

In addition to shopping tasks, the internet has enabled a wide range of other services to be modified and customized as desired by users in the marketplace. One sector where services have been particularly targeted is transportation, and a wide range of possibilities have been created for users of transportation services. One such possibility is ridesharing, where a user may coordinate, via, for example, a web-based interface, one or more rides from an origin to a destination from other users (e.g., drivers) operating vehicles near the user.

When not carrying out a rideshare, many rideshare operators perform a roaming operation awaiting a subsequent rideshare request in hopes of finding such a rideshare. Once a request is received, the rideshare operator navigates to the user's origin location to pick up the user for a ride to a destination. Such roaming actions are an inefficient use of both the rideshare operator's time and resources (e.g., energy expenses, vehicle wear, etc.)

### SUMMARY OF THE DISCLOSURE

The present inventor has recognized that to improve user convenience, it may be possible to utilize rideshare services and operators to facilitate parcel collection for a user of the rideshare service and operator. The present inventor has further recognized that by utilizing the services of the rideshare operator, roaming, which wastes time and resources (e.g., energy, vehicle wear, etc.) may be reduced or eliminated by converting the time and resources into parcel collection services for a rideshare user.

According to embodiments of the present disclosure, a system including a processor and a non-transitory computer-readable medium communicatively coupled to the processor and storing instructions executable by the processor is provided. The instructions cause the processor to perform operations including receiving, from a user, a rideshare request comprising an origination point and a destination location, determining that one or more parcels destined for delivery to the user are available for collection, determining, based on a collection location associated with each of the one or more parcels and at least one of the origination point and the destination location, a route that enables collection of at least one of the one or more parcels, and directing a rideshare operator along the route to the collection location associated with at least one of the one or more parcels.

By providing systems according to the present disclosure, parcel collection for a rideshare user may be facilitated and the overall delivery experience improved.

Further, the otherwise wasted roaming time and resources of the rideshare operator may be put to use, thereby optimizing resource use and leading to overall emission reduction, by eliminating redundant trips.

Collection by at least one of the rideshare operator and the user may be prioritized at the collection location.

The operations may further include notifying the collection location of a proximity of the user to the collection location based on at least location tracking information associated with the rideshare operator.

The collection location may include one or more smart lockers.

The system may further include a second rideshare operator configured to collect at least one of the one or more parcels and deliver the at least one of the one or more parcels to a designated collection location.

The second rideshare operator may be associated with a public bus system.

The operations may further include providing an application programming interface (API) accessible by one or more rideshare operators, the API being configured to enable the rideshare operator to link the user with the one or more parcels.

The API may further configured to provide a wait time associated with collection of a parcel at the collection location.

The linking may based on at least one of a unique user identifier and a unique package identifier.

The determining that one or more parcels destined for delivery to the user are available for collection is based at least on a notice delivered to the user.

The operations may further include coordinating collecting, by the rideshare operator, one or more to-be-sent parcels from one or more entities based on the route and delivering the one or more to-be-sent parcels to a delivery service

According to further embodiments, a method for facilitating parcel collection is provided. The method includes receiving, at a server, a rideshare request from a user comprising an origination point and a destination location, determining that one or more parcels destined for delivery to the user are available for collection, determining, based on a collection location associated with each of the one or more parcels and at least one of the origination point and the destination location, a route that enables collection of at least one of the one or more parcels, and directing a rideshare operator to the collection location associated with at least one of the one or more parcels.

The method may further include, prioritizing collection of the one or more parcels at the collection location for at least one of the user and the rideshare operator.

The method may further include notifying the collection location of a proximity of the user to the collection location based on GPS information associated with the rideshare operator.

The method may further include coordinating with a second rideshare operator to collect at least one of the one or more parcels and deliver the at least one of the one or more parcels to a designated collection location.

The method may further include, providing an application programming interface (API) accessible by one or more rideshare operators, the API being configured to enable the rideshare operator to link the user with the one or more parcels.

The linking may be based on at least one of a unique user identifier and a unique package identifier.

The method may further include providing, by the API, a wait time associated with collection of a parcel at the collection location.

The method may further include coordinating collection by the rideshare operator of one or more to-be-sent parcels from one or more entities based on the identified route, and delivering the to-be-sent parcels to a delivery service.

According to yet further embodiments, a method for facilitating parcel collection is provided. The method includes receiving, at a server, a rideshare request from a user comprising an origination point and a destination location via a rideshare application, determining, based on a user identifier associated with the user, that the user is a rideshare parcel-collection subscriber, determining, using the user identifier, that one or more parcels destined for delivery to the user are available for collection at one or more collection locations, determining, based on each collection location associated with each of the one or more parcels and at least one of the origination point and the destination location, one or more routes that enables collection of at least one of the one or more parcels, providing the one or more routes to at least one of a rideshare operator and the user, receiving, from the user, a selection of a selected route from among the one or more routes, and directing the rideshare operator along the selected route to at least one of the one or more collection locations.

It is intended that combinations of the above-described elements and those within the specification may be made, except where otherwise contradictory.

It is to be understood that both the foregoing general description and the following detailed description are exemplary and explanatory only and are not restrictive of the disclosure, as claimed.

The accompanying drawings, which are incorporated in and constitute a part of this specification, illustrate embodiments of the disclosure and together with the description, serve to explain the principles thereof.

### BRIEF DESCRIPTION OF THE DRAWINGS

FIG. 1 is a block diagram of a rideshare parcel collection system according to embodiments of the present disclosure;

FIG. 2 is a swim-lane diagram an example of the interactions between components of the system of FIG. 1 according to some embodiments;

FIG. 3 is a modified rideshare parcel collection system according to further embodiments of the present disclosure;

FIG. 4 is a swim-lane diagram highlighting exemplary message flow between components of the system of FIG. 3;

FIG. 5 is a flowchart showing an exemplary method for rideshare parcel collection according to embodiments of the present disclosure; and

FIG. 6 illustrates an exemplary computing device 600 that may be specifically configured to perform one or more of the processes described herein.

### DESCRIPTION OF THE EMBODIMENTS

Reference will now be made in detail to the present exemplary embodiments of the disclosure, examples of which are illustrated in the accompanying drawings.

Wherever possible, the same reference numbers will be used throughout the drawings to refer to the same or like parts.

The disclosed embodiments may provide one or more of the features and benefits mentioned above and/or various additional and/or alternative features and benefits that will be made apparent herein.

As used herein, the term “parcel” is meant to include any type of item that is delivered by a delivery service, such as the U.S. Postal Service (USPS™), the Federal Express company (FedEx™), the United Parcel Service company (UPS™), or the like. Thus, a “parcel” may be or include any delivery item that is delivery by a national postal service or a commercial delivery service, such as a postcard, a letter, an envelope containing an item, a cardboard box or other container enclosing an item, an item or collection of items wrapped in paper, and the like.

Exemplary rideshare parcel collection systems and methods are described herein. The systems and methods described herein may enable a user to organize a rideshare and collect a parcel from, for example, a collection location (e.g., without entering a building associated with the collection location, with minimal or no wait time at the fulfillment location, etc.) and then to be transported to a destination location by a rideshare operator. Collection of one or more parcels may be facilitated at the collection location, and a determined estimated time of arrival may be signaled to facilitate timely preparation of the parcel for collection and, in turn, convenient and efficient collection of the parcel at the collection location.

To illustrate, an exemplary system includes a processor and a non-transitory computer-readable medium communicatively coupled to the processor and storing instructions executable by the processor to receive, from a user, a rideshare request comprising an origination point and a destination location, determine that one or more parcels destined for delivery to the user are available for collection, identify, based on a collection location associated with each of the one or more parcels and at least one of the origination point and the destination location, a route that enables collection of at least one of the one or more parcels, and direct a rideshare operator to the collection location associated with at least one of the one or more parcels.

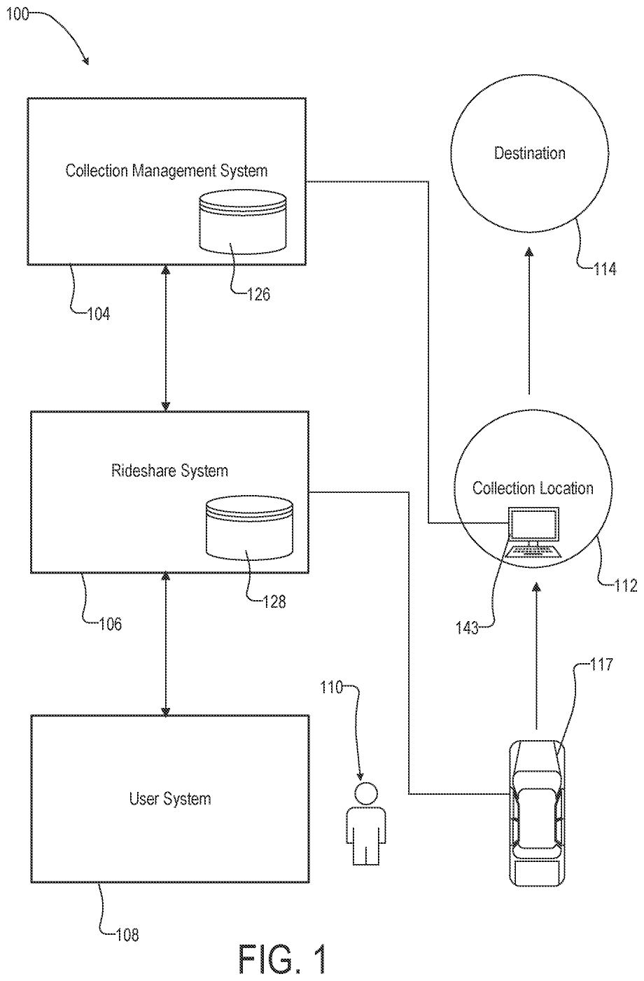

FIG. 1 illustrates an exemplary configuration 100 in which an rideshare parcel collection system is employed according to principles described herein. As shown, configuration 100 may include a rideshare system 106 communicatively coupled to a user system 108 and a parcel collection system 104.

The user system 108 may be associated with a user 110 at a particular location (e.g., a user origination point), which may be a geographic location at which the user system 108 and/or a user of the user system 108 is located. The rideshare system 106 and the user system 108 may be configured to perform one or more of the functions and operations described herein to facilitate provision of a rideshare service to a user 110 and collection of one or more parcels by a user 110 and/or a rideshare operator 117 at one or more collection locations 112 before proceeding a user's desired destination location 114.

The user 110 may correspond to any suitable entity requesting rideshare services, i.e., services whereby a rideshare operator 117 (i.e., a vehicle operator participating in, or otherwise employed by a rideshare service provider) agrees to pick up and transport the user 110 from a origination point to a destination 114. For example, the user 110 may be a person seeking transportation from the origin point to the destination while minimizing time and cost for the transportation.

The rideshare operator 117 may be any vehicle operator, such as a private entity, a commercial entity, or hybrids thereof. Rideshare services, rideshare operators, and providers thereof are well known in the art and will not be described further herein.

A collection location 112 may include any suitable location at which a user 110 may pick up or collect one or more parcels intended for delivery to the user 110, such as a geographic location at which a user may collect the one or more parcels. According to some embodiments, a collection location 112 may include a structure configured to facilitate on-site collection of parcels. For example, a collection location 112 may form part of a warehouse associated with a merchant and/or parcel carrier (e.g., delivery service), a drive-thru style window, a curbside kiosk, and/or a series of access-controlled storage boxes (e.g., smart lockers) positioned within reach of a user on foot or in a vehicle, for example. For instance, a collection location 112 may include one or more kiosks that are installed in a parking lot of a carrier's brick-and-mortar facility and that may include one or more drive-thru style windows with indications as to where a particular user might approach to collect one or more parcels. Such configurations are exemplary only, and collection location 112 may be configured in any suitable manner to facilitate collection of the one or more parcels.

The user system 108 may include one or more devices configured to be operated by a user and/or to perform the user system functions and operations described herein. For example, the user system 108 may include any suitable device configured to enable a user to send and receive information between the user system 108 and a separate device, via a network (e.g., the Internet). In certain embodiments, the user system 108 may be or include a handheld terminal (e.g., a mobile phone, a digital tablet device, a personal digital assistant, etc.) or a personal computing device (e.g., a laptop computer, a desktop computer, etc.), among others.

The user system 108 may be communicatively connected to one or more networks (not shown) to facilitate the sending and receiving of messages and may communicate via any suitable communication device and protocol. For example, the user system 108 may include an ethernet interface, a Wi-Fi interface, and/or a mobile data interface (e.g., 4G, LTE, etc.), among others, and software configured to enable communication over the provided interfaces.

The user system 108 may be configured to communicate using any suitable message format. For example, the user system 108 may be configured to transmit and receive API calls (e.g., RESTful, SOAP, etc.) via, for example, a microservice (e.g., a microservice implemented on one or more web service providers servers) using any suitable architecture, protocol, or communications technology for interfacing between remote computing devices (e.g., JSON, XML, etc.)

The user system 108 may include one or more devices configured to obtain and transmit information related to the geographic location of the user system 108 and thereby, a location corresponding to the location of the user 110 operating the user system 108. For example, the user system 108 may be or include a mobile device (e.g., a smart phone) configured to obtain information related to the geographic location of the mobile device based on Global Positioning System (GPS) and/or cellular triangulation, for example.

The user system 108 may further include one or more user interfaces configured to enable a user 110 to interact with various functions of the user system 108 and to allow the user 110 to send and receive messages. According to embodiments disclosed herein, the user system 108 may include a display (e.g., a touch screen) enabling a user 110 to view and compose messages, an audio speaker enabling the user 110 to hear messages, and one or more input devices (e.g., keyboard, mouse, microphone, etc.) enabling user input.

In certain embodiments, the user system 108 may be configured to enable interaction with one or more rideshare providers, via, for example, an application interface (e.g., a graphical user interface “GUI”). For example, the user 110 may interact with an application (also known as an “app”) running on the user system 108 to request a ride from a rideshare provider from an origin point to a destination location 114 desired by the user 110. The request may take place from any suitable application operating on the user system 108, e.g., a web browser, an app similar to the Uber™ or Lyft™ apps, etc., enabling interaction and information exchange with the rideshare system 106 (e.g., a web server) of a rideshare provider, e.g., via a user interface on the user system 108 and one or more APIs available on the server 106, among others.

The user system 108 may store a user identifier (not shown) including any suitable combination of data configured to allow the identification of a user 110 of the user system 108 by a computing device and/or a user and that may be transmitted and received via electronic means (e.g., a network). For example, a user identifier may include a numeric string (e.g., a telephone number), an alphanumeric string (e.g., an e-mail address), a barcode, a QR code, a sound combination, or any other suitable identifying data that can be transmitted and received and used to identify a user 110. According to some embodiments, a user 110 may be assigned a unique user identifier (e.g., an email address, a telephone number, a hash of a serial number, etc.), and the unique user identifier may be stored in data storage present on user system 108.

The user system 108 may be configured to communicate with a rideshare system 106, including providing information to and receiving information from the rideshare system 106. For example, the user system 108 may provide information related to the user 110 of the user system 108 (e.g., a user identifier), the location associated with the user system 108 (e.g., a geographic location of the user system 108 and/or the user 110 of user system 108), and the destination desired by the user (e.g., geographic coordinates, point of interest, etc.) to the rideshare system 106. The user system 108 may provide such information to the rideshare system 106 to enable identification of a rideshare operator 117 for providing the requested ride and to facilitate user collection of one or more parcels at collection location 112 as described below.

The rideshare system 106 may be configured to perform one or more functions and operations described herein to provide rideshare services (e.g., coordination of a rideshare service between a rideshare user 110 and the rideshare operator 117) and facilitate collection of parcels intended for the rideshare user 110. To that end, the rideshare system 106 may be or include any suitable computing devices, such as hardware and software configured to perform the operations of the rideshare system 106 described herein. For example, the rideshare system 106 may include one or more computing devices (e.g., servers, personal computers, etc.) configured to execute one or more software applications or programs to provide functionality and/or application programing interfaces (APIs) as described herein.

The rideshare system 106 may be communicatively connected to one or more networks (not shown) to facilitate the sending and receiving of data (e.g., messages, information, etc.) and may communicate via any suitable communication device and protocol. For example, the rideshare system 106 may include an ethernet interface, a Wi-Fi interface, a mobile data interface (e.g., 4G, LTE, etc.), among others, and software configured to enable communication over the provided interfaces.

The rideshare system 106 may include one or more applications configured to enable communication (e.g., sending and transmitting of data) using any suitable protocol and message format. For example, the rideshare system 106 may include applications configured to transmit and receive API calls (e.g., RESTful, SOAP, etc.) via, for example, a microservice (e.g., a microservice implemented on one or more web service servers) using any suitable architecture, protocol, or communications technology for interfacing between remote computing devices (e.g., JSON, XML, etc.)

The rideshare system 106 may be configured to store information corresponding to the user system 108 and the user 110 (e.g., a device identifier for the user system 108, a user identifier, a user address, a user phone number, frequently travelled routes, frequented points of interest, etc.), using, for example, one or more databases 128. Additionally, information related to each of the messaging services present on the user system 108 may be stored by the rideshare system 106, to enable direct communication between the rideshare system 106 and the user system 108 (e.g., to facilitate tracking of geographic location information). To this end, an identifier associated with the user system 108, (i.e., a device identifier), may be registered with the rideshare system 106, e.g., as part of the subscription service information associated with the user 110 based on subscription services (e.g., rideshare services, parcel collection services, etc.) offered by the provider of the rideshare system 106.

In certain examples, the rideshare system 106 may include one or more navigation and/or mapping applications configured to identify, calculate, or otherwise determine and plan travel routes, modify travel routes, determine various aspects of travel, etc. For example, the rideshare system 106 may include a stand-alone navigation application configured to identify or determine one or more proposed routes from the user 110's origin point or location to a destination location 114, with one or more collection location(s) 112 as a waypoint, and provide the proposed routes to the rideshare operator 117 to enable the rideshare operator 117 to navigate or drive along a selected route.

In other examples, the rideshare system 106 may be configured to interface with one or more separate navigation systems, such as one or more webservices (e.g., via API calls) associated with a navigation provider (e.g., MAPQUEST™, GOGGLE MAPS™, WAZE™, BING MAPS™, etc.). For example, geographic location information received from the user system 108 may be provided by the rideshare system 106 to a navigation provider via an API request. In response to such a request, the webservice of the navigation provider may return (e.g., via a response) navigation information including a proposed route from the origin point or location of the user 110 to the destination 114 via the collection location 112. The proposed route may be provided, e.g., by the rideshare system 106 or by the webservice, to any suitable device (e.g., a navigation system, a mobile phone, etc.) in the vehicle of rideshare operator 117 to enable the rideshare operator 117 to follow the proposed route and pick up a parcel at the collection location 112 while on the way to the destination.

The rideshare system 106 may include and/or provide one or more user interfaces and/or applications configured to provide information to the operator of the rideshare system 106, the rideshare user 110, the collection management system 104, etc. For example, the rideshare system 106 may provide an interface and/or application to one or more display devices configured to provide text and/or image data to a rideshare operator 117 (e.g., a mobile device of the rideshare operator 117), the data being related to one or more of the location of the user 110, parcels available for user collection, etc.

The rideshare system 106 may be configured to receive a request for a rideshare from the user 110, for example, via an application running on the user system 108, such a smart phone, including an origination point and a destination location 114, determine that one or more parcels addressed or destined for delivery to the user 110 are available for collection, calculate, determine, or identify, based on the collection location 112 associated with each of the one or more parcels and at least one of either the origination point or the destination location 114, a route that enables collection of at least one of the one or more parcels (i.e., a route that includes the collection location 112), and direct an appropriate rideshare operator 117 to one or more collection locations 112 to enable collection of the one or more parcels for the user 110.

According to some embodiments, the rideshare system 106 may be configured to select one or more suitable rideshare operators 117 for a requested rideshare from a user 110. For example, the rideshare system 106 may determine one or more suitable rideshare operators 117 based on proximity to the user origin location, participation in the rideshare parcel collection system, etc. The rideshare system 107 may then enable each of the determined one or more suitable rideshare operators 117 to accept the rideshare request from the user 110 and/or to be selected by the user 110 (e.g., via an interface on user system 108).

The collection management system 104 may be or include one or more computer systems configured to provide information associated with one or more parcels available for collection. To that end, the collection management system 104 may include one or more computing devices configured to perform one or more of the operations and functions described herein. For example, the collection management system 104 may send and receive messages and/or information related to parcels for a user 110, over one or more networks (e.g., LAN, Internet, etc.).

The collection management system 104 may also include or be in communication with one or more output devices, for example, a collection management terminal 143 located at a collection location 112 and comprising a display. The collection management system may send information related to a user's one or more parcels to collection management terminal 143 to output the information, for example, to staff at the collection location 112.

The collection management system 104 may be configured to send and receive messages associated with parcels that are ready for collection to the rideshare system 106 and the user system 108, among others. Exemplary messages may include messages containing parcel information, parcel location information (e.g., the address of the collection location 112), user information, etc. Therefore, the collection management system 104 may include one or more communication interfaces configured to send and receive such messages. For example, the collection management system 104 may include interfaces for sending and receiving one or more of email messages, text messages (e.g., SMS, MMS, etc.), instant messages, and/or any other suitable communications. Messages sent by the collection management system 104 may include, for example, a missed delivery notification, an parcel status message (e.g., a message indicating that parcels are available at a collection location 112), and parcel collected notifications, among others.

In addition, the collection management system 104 may be configured to provide one or more applications configured to provide an application programming interface (i.e., API) allowing other applications, either remotely located or co-located with the collection management system 104, to execute functionality associated with the collection management system 104. The APIs may be implemented in any suitable application and may be exposed via any suitable access protocol, for example, REST, SOAP, etc. For example, when a user 100 who is subscribed to the parcel collection service of a rideshare provider requests a rideshare trip via the rideshare provider's app, the rideshare system 106 may call certain functions of the API of the collection management system 104 in order to obtain parcel information, parcel location information, user information, etc. that is associated with the user 100, if there is any such information currently available.

According to another example, an API provided by the collection management system 104 may be configured to receive a rideshare estimated time of arrival at the collection location 112 to enable and/or facilitate timely or prioritized collection of one or more parcels for the user 110, as will be described below.

Alternatively, or in addition, the API may be configured to provide information regarding the wait time at the collection location 112. For example, where prioritized collection is not available at the collection location 112, the user 110 and/or the rideshare operator 112 may be informed via the API of the current wait time based on, for example, a current queue length at the collection location 112, where the queue length may be measured or estimated using digital images of the queue from a camera connected to a computing system at the collection location 112. Wait time information may be provided, for example, on a display of the user system 108, (e.g., the smartphone of the user 100) among others.

The collection management system 104 may be operated and maintained by a parcel carrier or delivery service (e.g., USPS™, FedEx™, UPS™, etc.), or a parcel carrier may contract or otherwise obtain services from a third-party fulfillment provider to operate and maintain the collection management system 104.

The collection management system 104 may include or be associated with one or more databases 126 configured to store and provide parcel-related information for parcels to-be-delivered to users of the system 100, such as the user 110. Parcel-related information may include, for example, parcel identifiers, one or more user identifiers associated with each to-be-delivered parcel (e.g., the name and address of the user 110 to whom the parcel is addressed), parcel weight, parcel dimensions, sender information (e.g., the name and return address of the sender), delivery attempt information (e.g., unique delivery attempt identifier), collection location of the parcel (e.g., the address of the collection location 112), etc. The one or more databases 126 may be configured to return at least a portion of the parcel-related information in response to a query, for example, based on one or more user identifiers and/or a device identifier for the user system 108 and/or a parcel identifier.

In various embodiments, the collection management system 104 may be linked with one or more other collection management systems 104 (not shown) located at other geographic positions. In such embodiments, a single “master” collection management system 104 may provide coordinating communications among the linked systems 104. According to some such embodiments, upon receipt of a rideshare request from the user system 108, the collection management system 104 may query the other collection management systems 104 to determine which, if any, collection location 112 is holding a parcel(s) for the user 110 making the rideshare request. Such a query may be performed based on, for example, a user identifier (e.g., address, telephone number, unique user identifier, etc.), a device identifier for the user system 108, or the like.

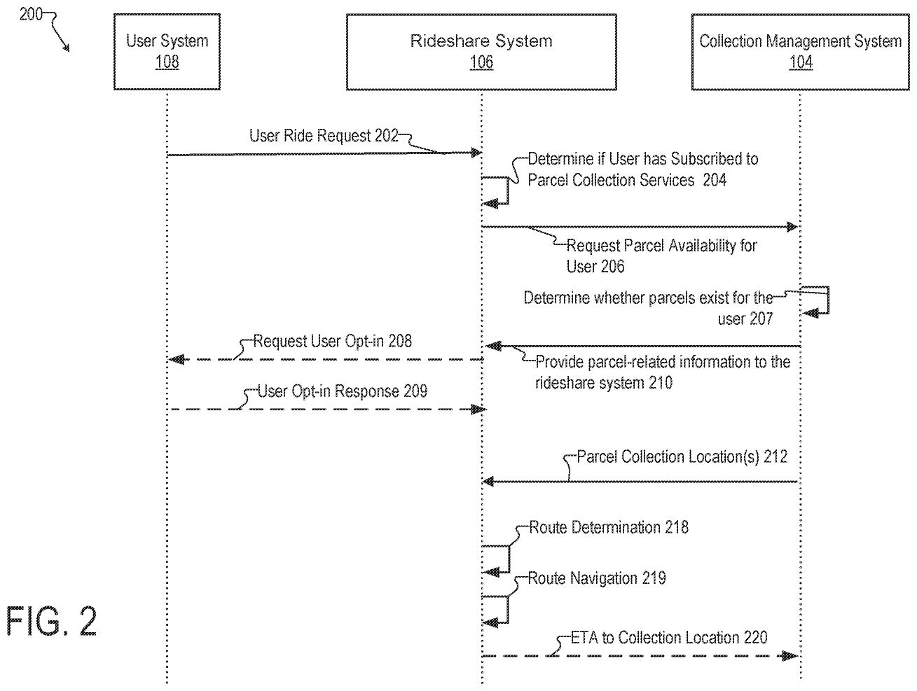

FIG. 2 is a swim-lane diagram showing and example of the interactions 200 between components of the system of FIG. 1 while carrying out some embodiments of the present disclosure. The user 110 may initiate a rideshare request from a user system 108 that sends the request, e.g., via a mobile device, to the rideshare system 106 (operation 202). The rideshare request may include information identifying or associated with the user (e.g., a unique identifier, a telephone number, etc.), as well as ride specific information such as origin information and destination information (e.g., addresses for user-pickup location and for destination 114, points of interest, intersection, etc.)

The rideshare system 106 may receive the rideshare request, and based on the user information provided with the request, determine whether the user 110 has subscribed to parcel collection services (operation 204). For example, the rideshare system 106 may query a database 128 storing user profile information such as, for example, subscription services, typical user travel, etc. to determine whether or not the profile information for the user 110 indicates parcel collection services.

Once it is determined that the user 110 is a subscriber to parcel collection services, the rideshare system 106 may request information from the collection management system 104 to determine whether one or more parcels addressed or destined for delivery to the user 110 are available for collection (operation 206). For example, the rideshare system 106 may provide a user identifier (e.g., a unique identification number and/or address information) associated with the user 110 in the request to the collection management system 104. The collection management system 104 may then query one or more collection locations 112 to determine whether any parcels exist for collection by the user 110 based on the user identifier (operation 207) and return information related to the one or more parcels (e.g., unique parcel identifier, parcel weight, sender information, parcel dimensions, etc.), if any. In such implementations, upon receiving the query, a device at the collection location 112 may search a list or database containing information describing the parcels that are currently stored there for any parcels that are addressed to a person that matches the user identifier, which may be the user's name and/or address, or the like.

According to some embodiments, the collection management system 104 may have access to a database 126 including a master list of parcels available for collection at all collection locations 112, and storing parcel information linked to the user identifier by, for example, a unique parcel identifier. Alternatively, or in addition, collection management system 104 may query each associated collection location 112 to determine the presence of one or more parcels for the user 110, where each collection location 112 stores user and parcel information in an associated database (not shown), for example.

When it is determined that one or more parcels are available for the user 110 at one or more collection locations 112, the collection management system 104 may provide parcel-related information to the rideshare system 106 (e.g., collection location information, parcel ID, parcel weight, sender information, etc.) (operation 210). For example, a parcel may be available for collection by the user 110 at a post office, a UPS™ store, or other carrier location that serves as the collection location 112, and the collection management system 104 may provide geographic location information regarding the post office, a parcel identifier, parcel dimensions, parcel weight, sender information, etc. to the rideshare system 106. In various embodiments, the rideshare system 106 may present such information to the rideshare operator 117 and/or the user 110 via the user system 108 (e.g., using a display on the user system 108).

The rideshare system 106 may present such information in the context of an opt-in request to the user 110 to determine whether the user 110 would like to use the rideshare system 106 to collect the one or more parcels available for collection at the one or more collection locations 112 (operation 208). As signified by the dashed line in the example shown in FIG. 2, the implementation of a user opt-in request may be optional depending on, for example, a user's preference indicating the desire to be asked each time a parcels is identified during a rideshare request.

The opt-in request may provide parcel-related information to the user 110 for example, sender information, parcel ID, parcel weight, dimensions, etc., and may provide the user with, for example, an interface enabling selection of opting in or opting out for the present rideshare. Based on this interface and the information provided, the user 110 may provide a response to the opt-in request (operation 209). Where the user chooses not to opt in for the present rideshare, the rideshare may be carried out in a normal manner with a rideshare operator 117 picking up the user 110 and transporting the user 110 to the destination 114 without any intermediate parcel-collection stop.

When the user chooses to opt in to parcel collection for the present rideshare, or where the user opt in request is not implemented, the rideshare system 106 may receive from the collection management system 104 information associated with one or more parcel collection locations 112 at which parcels exist for collection by the user 110 (operation 212). The information associated with the one or more parcel collection locations 112 may include, for example, geographic location information, hours of operation, priority information, and identifying information (e.g., a location identification number), among others.

Alternatively, or in addition, a user 110 may have received a notice of missed delivery, for example via email, via text, or via a delivery service at a receiving location associated with the user 110 (e.g., a home mailbox). Such a notice may include information related to one or more parcels available for collection by the user 110, for example, a parcel identifier and a collection location 112. A user in possession of a missed delivery notice and making a rideshare request (operation 202) may indicate via the rideshare user interface a desire to collect the parcel during the rideshare. The user 110 may therefore provide to the rideshare system 106, via the interface, information from the notice of missed delivery, including, for example, a parcel identifier and a collection location 112 at which the parcel is located.

Using the collection location information provided by the collection management system 104, the rideshare system 106 may determine, calculate, or identify a route that includes the one or more collection locations 112 where respective parcels are located, while, for example, minimizing time and/or distance to the user's final destination 114 (operation 218). For example, the rideshare system 106 may utilize one or more navigation and/or mapping tools to determine one or more routes that include a collection location 112, where the rideshare operator 117 can stop so the user 110 can pick up a parcel, and then proceed to the destination 114. In making such a determination, information such as, for example, the geographic location and the hours of operation of the collection location 112 may be used in calculating, identifying, or determining the route.

According to some embodiments not shown in FIG. 2, a rideshare user 110 may be presented with one or more possible routes such that the rideshare user 110 may be permitted to approve or disapprove of one or more of the routes. For example, the rideshare system 106 may determine two routes enabling collection of a parcel at the collection location 112 on the way to arrival at the destination 114, and may present these routes to the user 110 for consideration, e.g., via the user system 108 of the user 110. The user may then select one or the other of the two routes to be followed by the rideshare operator 117. Alternatively, the user may not approve of either route and may simply proceed to the destination 114 without stopping at the collection location 112, or may approve the both routes and allow the rideshare operator 117 to select from the two routes, for example.

According to further embodiments, in addition to one or more route selections, a user may be provided with a supplemental fee to be charged for each of the determined routes and stops at one or more collection locations 112. For example, a route including an additional stop at a collection location 112 and traversing an additional distance over a non-collection route may be assessed a fee increase of 20% over a base fare. One of skill will recognize upon review of the disclosure that such an increase is exemplary only and that any amount may be agreed upon among rideshare users, rideshare operators, and operators of collection management system 104.

Alternatively or in addition, a “subscription fee” may be charged to a rideshare user who elects to opt-in (i.e., subscribe) to parcel collection services. For example a user may pay a fixed periodic amount (e.g., $20 per month) to participate in the rideshare parcel collection system, and such payment may, in some implementations, enable any number of stops for parcel collection without deviating from a base fare provided by rideshare operator 117. In other implementations, in addition to the fixed periodic subscription amount, and additional fee may also be charged based on route selection and number of collection location stops. Any such implementation is intended to fall within the scope of the present disclosure.

Once a route has been determined and/or selected, the rideshare system 106 may direct or navigate the rideshare operator 117 along the route to the collection location 112 to obtain a parcel(s) for the user 110 (operation 219). For example, rideshare operator 117 may receive a map and instructions for driving to the collection location 112 based on (e.g., along) the selected route, and then may stop at the collection location 112 to enable collection of the one or more parcels.

According to some embodiments, parcel collection at a collection location 112 may be prioritized for the user 110 and/or the rideshare operator 117. For example, a special priority queue may be provided at a collection location 112, the priority queue being for collection of parcels associated with the rideshare parcel collection system. In such an embodiment, the user 110 and/or the rideshare operator 117 arriving to collect one or more parcels may enter the special priority queue, and move more rapidly through the queue in order to collect the one or more parcels. For instance, consider the use case where the collection location 112 is a U.S. post office. In this use case, a special counter location (e.g., a drivethru window, a walkup window, etc.) may be provided for use only by subscribers of the rideshare parcel pickup system, while a standard counter location with a standard queue, e.g., having a wait time during busy periods, may be provided for other non-subscribers.

According to further embodiments, one or more controlled access storage boxes (e.g., automated smart lockers or the like, such as the USPS™ gopost parcel delivery lockers) may be provided at collection location 112, thereby enabling a user 110 and/or a rideshare operator 117 to open or access the storage box using, for example, an identifier (e.g., a scannable barcode, a keypad code, etc.) to obtain the parcel(s) destined for the user 110. Such an identifier may be provided, for example, to a user 110's email, a rideshare operator 117's email, via a rideshare application on the user system 108, etc. In such embodiments, the smart lockers may communicate with the collection management system 104 and provide information, such as the locker number and an identifier or access code, that the collection management system 104 may communicate to the user, for example, via the user system 108.

In embodiments that facilitate priority access or pick up for the user 110 and/or the rideshare operator 117, the rideshare system 106 may provide an estimated time of arrival (ETA) at the collection location 112 and/or collection location proximity information to the collection management system 104 (operation 220). For example, based on tracking information (e.g., global position information, traffic information, current speed, etc.) provided from the rideshare operator 117 to the rideshare system 106, the rideshare system 106 may estimate the time of arrival of the rideshare operator 117 at the collection location 112, and/or may determine a proximity of the rideshare operator 117 to collection location 112, and send the ETA and/or proximity information to the collection management system 104, which may send the information to the collection location 112. Accordingly, steps may be taken at the collection location 112 in advance of the user's arrival to prepare the one or more parcels for pick up by the user 110 or the rideshare operator 117 (e.g., pulling a parcel from inventory, placing the parcel at a customer service location serviced by a special priority queue, placing the parcel in a controlled access storage box, etc.).

Modifications to the above-noted interactions may be made without departing from the scope of the present disclosure. For example, according to some embodiments, the rideshare operator 117 upon receiving a rideshare request from the user 110, and based on, for example, proximity to a collection location 112 associated with a parcel for the user 110, may proceed first to the collection location 112, collect the parcel (e.g., in a prioritized manner), and then proceed to pick up the user 110 at the origination point, thereby providing the user 110 with the parcel, and eliminating the user stop at a collection location 112. As another example, the information describing the waiting-parcel collection location(s) 112 contained in the message for the operation 212 may be instead included in the message for the operation 210, such that the message for the operation 212 is eliminated.

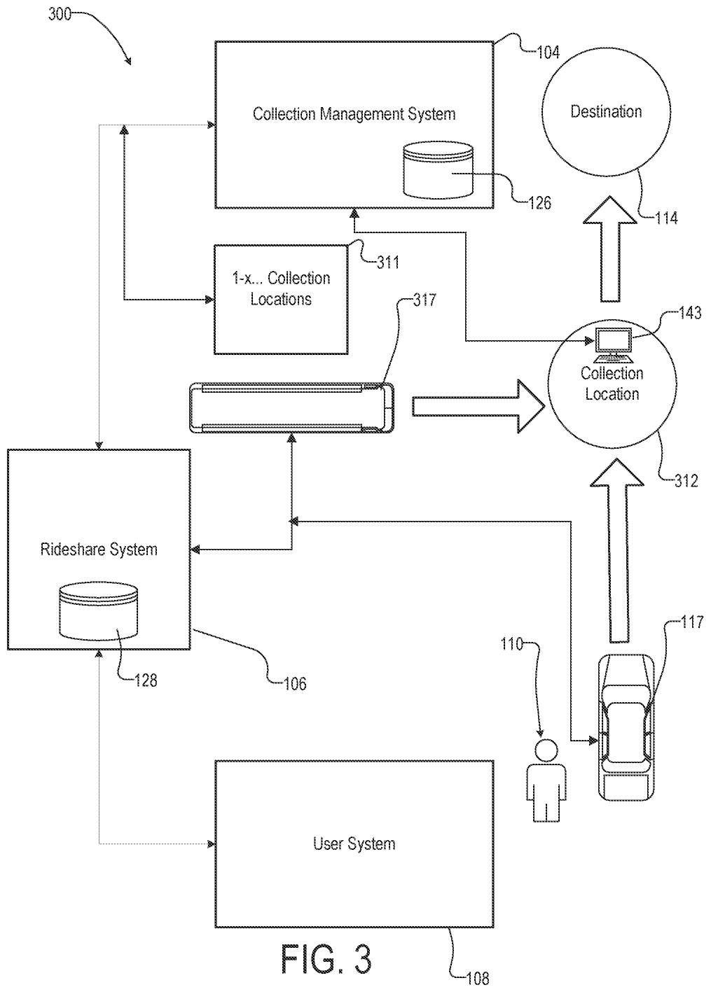

FIG. 3 is a modified rideshare parcel collection system 300 according to further embodiments of the present disclosure. According to such embodiments, one or more parcels for a user 110 may be located at disparate collection locations 311, 312, etc. In the embodiment shown in FIG. 3, the rideshare system 106 may coordinate with a second rideshare operator 317 to collect a parcel(s) from the one or more collection locations 311-1 . . . 3.11-x, and to deliver the one or more parcels to a designated collection location 312 serving as a waypoint during a user's rideshare trip.

Each remote collection location 311 may be configured similarly to the collection location 112 previously described, and may provide parcel-related information to the collection management system 104 enabling the collection management system 104 to store such data in the database 126. Thereafter, when receiving a rideshare request from a user 110, the rideshare system 106 may query the collection management system 104 to determine whether parcel(s) exist at multiple collection locations 311-x, and/or a designated collection location 312.

The designated collection location 312 may correspond to a collection location 112 configured to receive parcels and make them available for collection during a rideshare ride for any particular user 110. Therefore, the designated collection location 312 may be physically similar to the collection location 112 as described above (e.g., it may be a post office or the like), and further description will not be undertaken.

Each designated collection location 312 may be specific to a particular user 110. For example, depending on the travel habits of the user 110 and/or a selected preference for a specific collection location by the user 110, a particular collection location 112 may become the designated collection location 312 for that user 110. Similarly for a second user, a different collection location 112 may become the designated collection location 312 for the second user, based on user selection, frequent travel habits, etc.

The second rideshare operator 317 may comprise any suitable rideshare operator, and may be associated with the same entity operating rideshare system 106 or a different entity. For example, a second operator 317 may include another private operator/driver of a personal vehicle agreeing to participate in the rideshare parcel collection system affiliated with the rideshare system 106. Alternatively, or in addition, the second rideshare operator 317 may be associated with a separate and distinct entity from rideshare operator 117, for example, a public bus system, a taxi operator, another commercial carrier, etc.

The second rideshare operator 317 may operate a vehicle suitable for carrying parcels between collection locations 311-x, to facilitate collection of the parcels by one or more users 110 at a designated collection location 312. For example, the second rideshare operator 317 may operate a delivery vehicle such as, for example, a box truck, a bus, or other suitable vehicle. Although for purposes of the present example the second rideshare operator 317 is referred to in the singular, more than one second rideshare operator 317 may be implemented as desired within the scope of the present disclosure. For example, depending on the collection locations 311-1 . . . -x and the location of the designated collection location 312, two, three, or more second rideshare operators 317 may be used to collect parcels for one or more users 110 and deliver the parcels to the designated collection location 312.

The second rideshare operator 317 may be configured to operate between the collection locations 311-1 . . . -x, stopping at each collection location 311 having parcels for a user 110 to collect the parcels and to transport those parcels to the designated collection location 312, where the parcels are picked up by the user 110 and/or the rideshare operator 117. For example, where a user preference has not been set as described above, then in various embodiments the collection management system 104 and/or the rideshare system 106 may analyze previous rideshare origin points, routes, and/or destinations to determine that a first user 110 frequently passes by a particular collection location 112. The system 300 may then, for purposes of the first user 110, designate and store that particular collection location 112 as the designated collection location 312 for the first user 110, and all parcels associated with the firstr user 110 may be delivered to that designated collection location 312 by the second rideshare operator 317. A different second user 110, on the other hand, may have a different collection location 110 as their designated collection location 312, and the second rideshare operator 317 may deliver all parcels for the second user 110 to that second user's designated collection location 312.

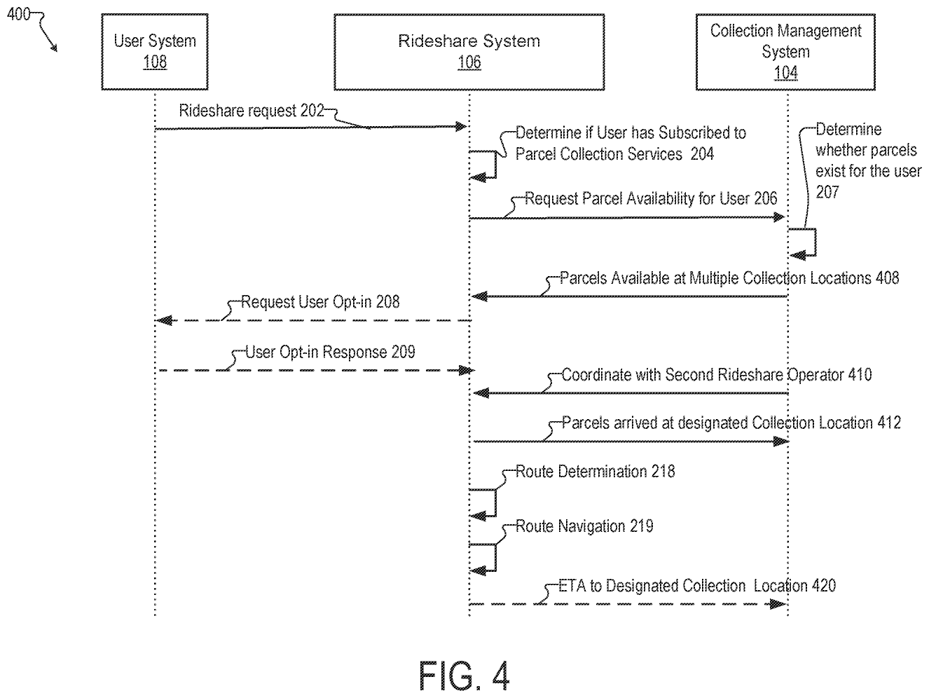

FIG. 4 is a swim-lane diagram highlighting exemplary message flow between components of the system of FIG. 3, and with several operations in common with FIG. 2. Operations in common with FIG. 2 will not be described in detail further.

In FIG. 4, in response to a user 110 requesting a ride share (operation 202), the rideshare system 106 may perform operations as described at FIG. 2 (e.g., operations 204-207) and subsequently receive from collection management system 104 an indication that multiple parcels are available at multiple collection locations 311 (operation 408). For example, one or more parcels destined for delivery to user 110 may be available for collection at a first collection location 311, with one or more other parcels destined for delivery to user 110 available for collection at a second collection location 311-x. The collection management system 104 in making such a determination (e.g., via a query to database 126) may send information regarding each of the first and second collection locations along with parcel information to the rideshare system 106. The information regarding each of the first and second collection locations as well as the parcel information may be similar to that information described above.

The collection management system 104 and the rideshare system 106 may then coordinate with a second rideshare operator 317 to collect at least one of the one or more parcels at the first collection location 311 and to deliver the collected one or more parcels to a designated collection location 312, for example, along a rideshare route of the first rideshare operator 117 (operation 410). For example, the first collection location 311 may be accessible to a public bus route, and a second rideshare operator 317 who may be a passenger or an operator of the bus, may stop at the first collection location 311 to collect the parcels on behalf of the user 110. The second rideshare operator 317 may then re-board the bus and travel onward to the designated collection location 312.

The second rideshare operator 317 may then deliver the parcels collected for the user 110 to designated collection location 312 and inform the collection management system 104 of the arrival (operation 412). Thereby, a user 110 may then collect the one or more parcels from designated collection location 312 during a rideshare, as described above with regard to FIG. 2.

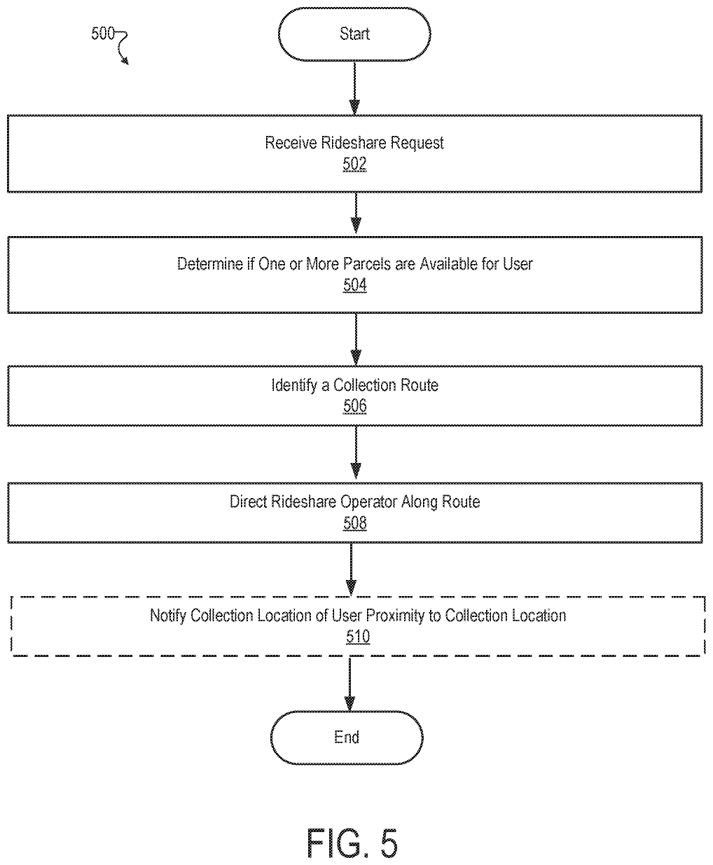

FIG. 5 is a flowchart showing an exemplary method 500 for rideshare parcel collection according to embodiments of the present disclosure. According to methods of the present disclosure, a rideshare request may be received by the rideshare system 106 from a user 110, the rideshare request including, for example, an origination point of the user 110 (e.g., an address or GPS coordinates provided by the user 110 or by the user system 108, such as a smartphone 108) and a desired destination location 114 (e.g., the address to which the user 110 wants to go) (block 502).

Based on information associated with the user, the rideshare system 106 may determine whether one or more parcels that are address or otherwise destined for the user are available for collection by the user at one or more collection locations 112 (block 504). In various embodiments, this determination may be made, for example, by querying or otherwise interacting with the collection management system 104, including sending the user information (e.g., the name and home address of the user 110) via, for example, an API provided by the collection management system 104. In such embodiments, the collection management system 104 may link a user to one or more parcels by searching its database 126 for records for parcels that have a destination name and/or a destination address that match or correspond to the user information sent by the rideshare system 106. In another example, collection management system 104 may receive a unique user identifier via the API, and search the database 126 based on the unique user identifier to link the user with one or more unique package identifiers associated with a parcel. The collection management system 104 may then send the parcel search results, including collection location information to the rideshare system 106. Note that the parcel search results may alternatively indicate that there are no parcels for the user 110.

Based on the collection location information received from the collection management system 104, a collection location for each parcel available for the user 110 may be determined, and a collection/rideshare route identified, calculated, or determined based on the origination point, the destination location 114, and the one or more collection locations 112 (block 506). For example, a route enabling fastest travel between the origination and the destination 114 while incorporating one or more of the collection locations 112 as waypoints may be determined and/or selected.

Once a route has been determined and selected, the rideshare operator 117 may be directed via the route from the origination point to each of the one or more collection locations 112 and finally to the destination 114 (block 508). For example, the rideshare operator 117 may receive mapping and navigation information from the rideshare system 106 and/or one or more mapping and navigation services.

According to some embodiments, a collection location 112 and/or collection management system 104 may be notified of a proximity of the user 110 to an intended collection location 112 (optional block 510). For example, based on location tracking information provided by one or more devices associated with the rideshare operator 117 (e.g., GPS tracker, mobile phone, etc.) to, for example, collection location 112, may be used to determine a user's proximity to the collection location 112. Such information may be used to prepare one or more parcels in advance for collection by the user 110.

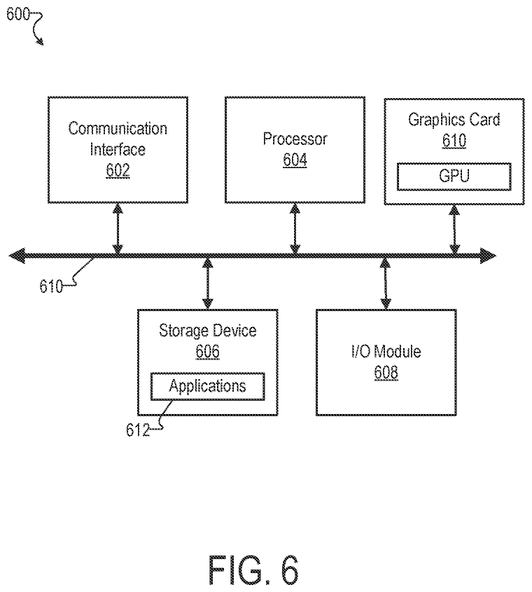

FIG. 6 illustrates an exemplary computing device 600 that may be specifically configured to perform one or more of the processes described herein. For example, one or more computing devices 600 may be implemented as user system 108, rideshare system 106, and collection management system 104, among others.

As shown in FIG. 6, computing device 600 may include a communication interface 602, a processor 604, a storage device 606, and an input/output (“I/O”) module 608 communicatively connected via a communication infrastructure 610. While an exemplary computing device 600 is shown in FIG. 6, the components illustrated in FIG. 6 are not intended to be limiting. Additional or alternative components may be used in other embodiments. Components of computing device 600 shown in FIG. 6 will now be described in additional detail.

Communication interface 602 may be configured to communicate with one or more computing devices. Examples of communication interface 602 include, without limitation, a wired network interface (such as a network interface card), a wireless network interface (such as a wireless network interface card), a modem, an audio/video connection, and any other suitable interface.

Processor 604 generally represents any type or form of processing unit capable of processing data or interpreting, executing, and/or directing execution of one or more of the instructions, processes, and/or operations described herein. Processor 604 may direct execution of operations in accordance with one or more applications 612 or other computer-executable instructions such as may be stored in storage device 606 or another computer-readable medium.

Storage device 606 may include one or more data storage media, devices, or configurations and may employ any type, form, and combination of data storage media and/or device. For example, storage device 606 may include, but is not limited to, a hard drive, network drive, flash drive, magnetic disc, optical disc, RAM, dynamic RAM, other non-volatile and/or volatile data storage units, or a combination or sub-combination thereof. Electronic data, including data described herein, may be temporarily and/or permanently stored in storage device 606. For example, data representative of one or more executable applications 612 configured to direct processor 604 to perform any of the operations described herein may be stored within storage device 606. In some examples, data may be arranged in one or more databases residing within storage device 606.

I/O module 608 may include one or more I/O modules configured to receive user input and provide user output. One or more I/O modules may be used to receive input. I/O module 608 may include any hardware, firmware, software, or combination thereof supportive of input and output capabilities. For example, I/O module 608 may include hardware and/or software for capturing user input, including, but not limited to, a keyboard or keypad, a touchscreen component (e.g., touchscreen display), a receiver (e.g., an RF or infrared receiver), motion sensors, and/or one or more input buttons.

I/O module 608 may include one or more devices for presenting output to a user, including, but not limited to, a graphics engine, a display (e.g., a display screen), one or more output drivers (e.g., display drivers), one or more audio speakers, and one or more audio drivers. In certain embodiments, I/O module 608 is configured to provide graphical data to a display for presentation to a user. The graphical data may be representative of one or more graphical user interfaces and/or any other graphical content as may serve a particular implementation.

One of skill in the art will recognize upon review of the present disclosure, that modifications may be made without departing from the scope of the present disclosure. For example, one or more rideshare operators 117 participating in the rideshare parcel collection system may be directed by the collection managements system 104 to collect to-be-sent parcels from one or more entities along a route. The collected to-be-sent may then be delivered or provided by the rideshare operator 117 to a collection location 112 (e.g., during a stop to collect parcels for a user 110) to enable processing by a delivery service or other carrier entity and subsequent delivery thereof.

According to such an example, one or more merchants or other entities may signal via an interface provided by the rideshare operator 106 and/or the collection management system 104, a desire to have one or more to-be-sent parcels collected for posting. Rideshare operator 106 may then coordinate with various rideshare operators 117 to pick up the to-be-sent parcels and to take them to collection location 112 for collection by a carrier or transporter, for example, during a subsequent rideshare operation for a user 110.

Throughout the description, including the claims, the term “comprising a” should be understood as being synonymous with “comprising at least one” unless otherwise stated. In addition, any range set forth in the description, including the claims should be understood as including its end value(s) unless otherwise stated. Specific values for described elements should be understood to be within accepted manufacturing or industry tolerances known to one of skill in the art, and any use of the terms “substantially” and/or “approximately” and/or “generally” should be understood to mean falling within such accepted tolerances.

Where any standards of national, international, or other standards body are referenced (e.g., ISO, etc.), such references are intended to refer to the standard as defined by the national or international standards body as of the priority date of the present specification. Any subsequent substantive changes to such standards are not intended to modify the scope and/or definitions of the present disclosure and/or claims.

It is intended that the specification and examples be considered as exemplary only, with a true scope of the disclosure being indicated by the following claims.

What is claimed is:

1. A system comprising:
a processor; and
a non-transitory computer-readable medium communicatively coupled to the processor and storing instructions executable by the processor to perform operations comprising:
receiving, from a user, a rideshare request comprising an origination point and a destination location;
determining that one or more parcels destined for delivery to the user are available for collection;
determining, based on a collection location associated with each of the one or more parcels and at least one of the origination point and the destination location, a route that enables collection of at least one of the one or more parcels; and
directing a rideshare operator along the route to the collection location associated with at least one of the one or more parcels.

2. The system according to claim 1, wherein collection by at least one of the rideshare operator and the user is prioritized at the collection location.

3. The system according to claim 2, wherein the operations further comprise notifying the collection location of a proximity of the user to the collection location based on at least location tracking information associated with the rideshare operator.

4. The system according to claim 1, wherein the collection location comprises one or more smart lockers.

5. The system according to claim 1, comprising a second rideshare operator configured to collect at least one of the one or more parcels and deliver the at least one of the one or more parcels to a designated collection location.

6. The system according to claim 5, wherein the second rideshare operator is associated with a public bus system.

7. The system according to claim 1, wherein the operations further comprise providing an application programming interface (API) accessible by one or more rideshare operators, the API being configured to enable the rideshare operator to link the user with the one or more parcels.

8. The system according to claim 7, where the API is further configured to provide a wait time associated with collection of a parcel at the collection location.

9. The system according to claim 7, wherein the linking is based on at least one of a unique user identifier and a unique package identifier.

10. The system according to claim 1, wherein the determining that one or more parcels destined for delivery to the user are available for collection is based at least on a notice delivered to the user.

11. The system according to claim 1, wherein the operations further comprise coordinating collecting, by the rideshare operator, one or more to-be-sent parcels from one or more entities based on the route and delivering the one or more to-be-sent parcels to a delivery service.

12. A method for facilitating parcel collection, the method comprising:
receiving, at a server, a rideshare request from a user comprising an origination point and a destination location;
determining that one or more parcels destined for delivery to the user are available for collection;
determining, based on a collection location associated with each of the one or more parcels and at least one of the origination point and the destination location, a route that enables collection of at least one of the one or more parcels; and
directing a rideshare operator to the collection location associated with at least one of the one or more parcels.

13. The method according to claim 12, further comprising, prioritizing collection of the one or more parcels at the collection location for at least one of the user and the rideshare operator.

14. The method according to claim 12, further comprising notifying the collection location of a proximity of the user to the collection location based on GPS information associated with the rideshare operator.

15. The method according to claim 12, comprising:
coordinating with a second rideshare operator to collect at least one of the one or more parcels and deliver the at least one of the one or more parcels to a designated collection location.

16. The method according to claim 12, further comprising, providing an application programming interface (API) accessible by one or more rideshare operators, the API being configured to enable the rideshare operator to link the user with the one or more parcels.

17. The method according to claim 16, wherein the linking is based on at least one of a unique user identifier and a unique package identifier.

18. The method according to claim 16, further comprising, providing, by the API, a wait time associated with collection of a parcel at the collection location.

19. The method according to claim 12, further comprising:
coordinating collection by the rideshare operator of one or more to-be-sent parcels from one or more entities based on the identified route; and
delivering the to-be-sent parcels to a delivery service.

20. A method for facilitating parcel collection, the method comprising:
receiving, at a server, a rideshare request from a user comprising an origination point and a destination location via a rideshare application;
determining, based on a user identifier associated with the user, that the user is a rideshare parcel-collection subscriber;
determining, using the user identifier, that one or more parcels destined for delivery to the user are available for collection at one or more collection locations;
determining, based on each collection location associated with each of the one or more parcels and at least one of the origination point and the destination location, one or more routes that enables collection of at least one of the one or more parcels;
providing the one or more routes to at least one of a rideshare operator and the user;
receiving, from the user, a selection of a selected route from among the one or more routes; and
directing the rideshare operator along the selected route to at least one of the one or more collection locations.
